(19) United States
(12) Patent Application Publication
(10) Pub. No.: US 2009/0015078 A1
(43) Pub. Date: Jan. 15, 2009

(54) Mover for a Linear Motor

(76) Inventors: Chia-Ming CHANG, Taichung (TW); Lieh-Feng Huang, Taichung (TW)

Correspondence Address: Dr. BANGER SHIA, 102 Lindencrest Ct., Sugar Land, TX, 77479-5201, US

(21) Appl. No.: 11/777,282

(22) Filed: Jul. 12, 2007

(51) Int. Cl. H02K 41/02

(52) U.S. Cl. 310/13

(57) ABSTRACT

A mover for a linear motor comprises a body. The body includes at least more than one engaging elements, at least more than one connecting element, at least more than one engaging portion and at least more than one connecting portion. With the engaging elements, connecting elements, engaging portions and connecting portions of the body, multiple movers can be connected with each other and perform the actuating action by cooperating with the stator, thus not only increasing the push force by achieving a continuous electric current multiplication of the linear motor, but also reducing the development cost of the mover, and achieving the high availability that the quantity of the movers can be increased or decreased according to the requirements of the client.

### BACKGROUND OF THE INVENTION

1. Field of the Invention

The present invention relates to a mover for a linear motor, and more particularly to a mover for a linear motor, which can be connected with multiple movers to increase the push force and reduce the development cost of the mover.

2. Description of the Prior Art

A linear motor disclosed in Taiwan Pat. No. 090128608 comprises a frame and an armature. The frame includes a ventilated seat, and the ventilated seat is disposed with a magnetic field yoke formed by two parallel rows of magnets. Each magnet row is formed by a staggered arrangement of permanent magnets with different polarity, and the permanent magnets of each magnetic row are connected with each other through the die resin. The armature is located between the two rows of magnets. The magnetic yoke acts as a stator, and the armature acts as a rotator, and the armature can moves relative to the magnetic field yoke. Additionally, a heat-absorbing portion of a heat pipe is connected with the armature, and a heat-emitting portion of the heat pipe is inserted into the ventilated seat.

However, when in use, the conventional linear motor has the following shortcomings:

1. being unable to increase or decrease push force: the linear motor is integrally formed, and the integral configuration is unable to connect and to continuously increase or decrease electric current of the linear motor, thus unable to increase or decrease the push force of the linear motor, so that it is unable to realize the practical utility.

2. Increasing the manufacturing cost: the specified size and the push force of the linear motor are fixed, if the client requires a linear motor with a comparatively larger push force, it needs remolding, thus increasing the cost of the client.

3. High cost: as described above, if the client requires a linear motor with a comparatively larger push force, it needs to be remolded, so the client must pay a great amount of fee, thus causing a high cost of the client.

4. Single use: After the linear motor is remolded, the finished linear motor can only provide a single push force which meets the client's requirement, and there is no way to increase or decrease the push force.

The present invention has arisen to mitigate and/or obviate the afore-described disadvantages.

### SUMMARY OF THE INVENTION

The primary objective of the present invention is to provide a mover for a linear motor. The mover for a linear motor of the present invention comprises a body which includes at least more than one engaging element, at least more than one engaging connecting element, at least more than one engaging portion, and at least more than one connecting portion. With the engaging elements, connecting elements, engaging portions and connecting portions of the body, multiple movers can be connected with each other and perform the actuating action by cooperating with the stator, thus not only increasing the push force by achieving a continuous electric current multiplication of the linear motor, but also reducing the development cost of the mover, and achieving the high availability that the quantity of the movers can be increased or decreased according to the requirements of the client.

The second objective of the present invention is to provide a mover for a linear motor, the mover for a linear motor comprises a body. The body includes at least more than one engaging element and at least more than one engaging portion. With the engaging elements and the engaging portions of the body, multiple movers can be connected with each other and perform the actuating action by cooperating with the stator, thus also achieving the same objective as the abovementioned.

### BRIEF DESCRIPTION OF THE DRAWINGS

FIG. 1 shows that a mover for a linear motor in accordance with the present invention is used together with a stator;

FIG. 2 is a perspective view of the mover for a linear motor in accordance with the present invention;

FIG. 3 shows that two movers for a linear motor are being assembled to each other in accordance with the present invention;

FIG. 4 shows that two movers for a linear motor are assembled together in accordance with the present invention;

FIG. 5 shows that another two movers for a linear motor are being assembled to each other in accordance with the present invention; and

FIG. 6 shows that another two movers for a linear motor are assembled together in accordance with the present invention.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

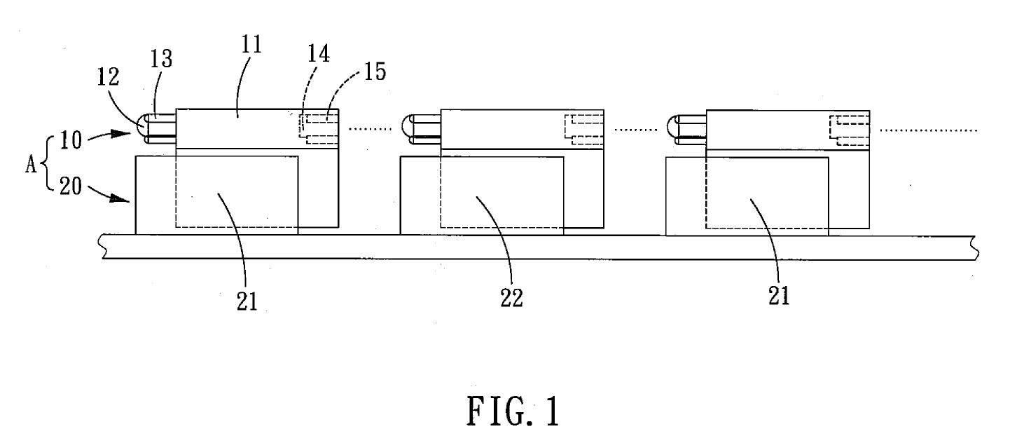

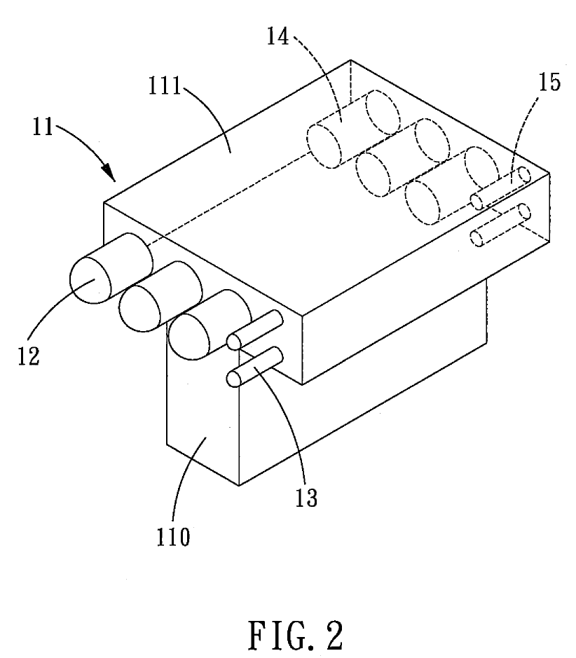

Referring to FIGS. 1-2, a mover for a linear motor A in accordance with a preferred embodiment of the present invention is provided at one end thereof with least one mover 10 and an elongated multi-segment stator 20. The mover 10 can be made up of more than one mover and used together with the stator 20 to increase the push force by achieving a continuous electric current multiplication of the linear motor A.

The mover 10 includes a three-phase electric current U, V, W and a T-shaped body 11. The body 11 includes a rectangular actuating portion 110 and a square-shaped adapting portion 111. The actuating portion 110 is disposed on the stator 20. On one end surface of the adapting portion 111 are disposed at least more than one protruding engaging element 12 in the form of a bullet head and at least more than one column-shaped connecting element 13. In an opposite end surface of the adapting portion 111 includes at least more than one round hole-shaped engaging portion 14 and at least more than one round hole-shaped connecting portion 15.

The stator 20 is a rectangular body, and a positive pole magnetic element 21 and a negative pole magnetic element 22 are alternately disposed on the stator 20. The positive pole magnetic element 21 and the negative pole magnetic element 22 can be made of soft or hard magnetic material or material with magnetism. The abovementioned stator 20 is a conventional device, so more details are omitted here.

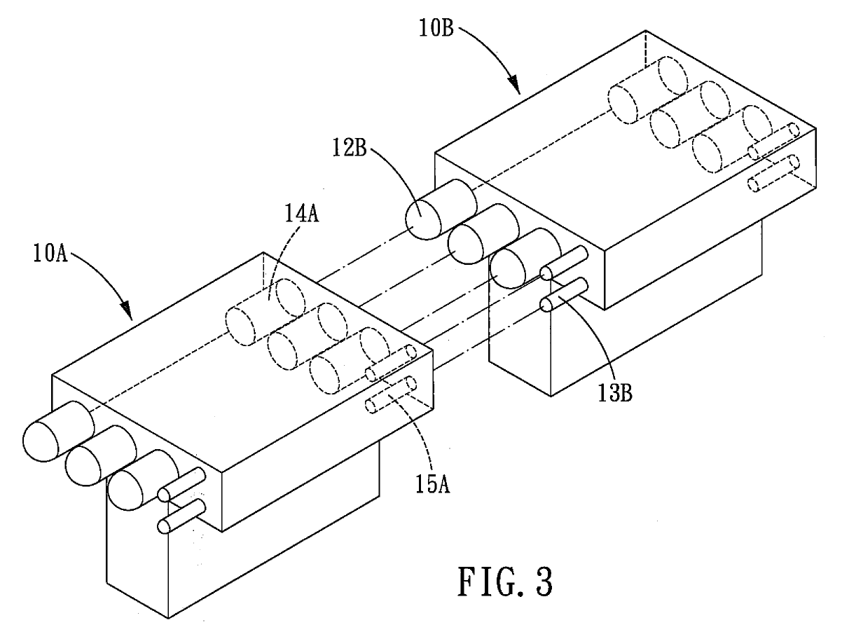

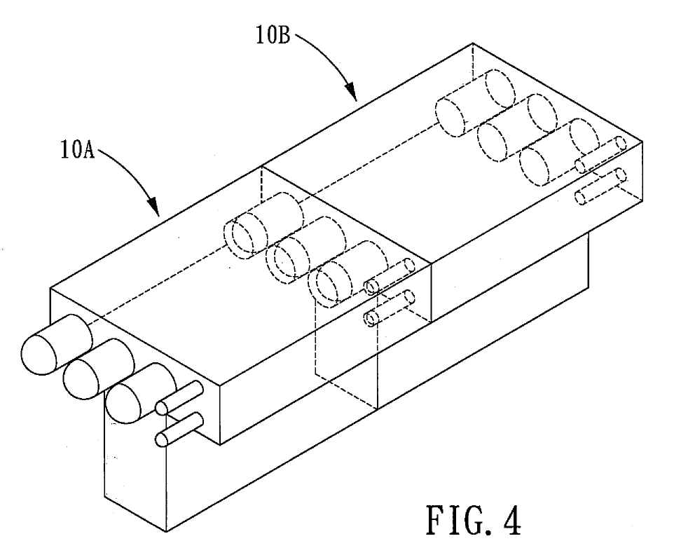

FIGS. 3-4 show that a mover 10B is assembled with another mover 10A, the engaging element 12B and the connecting element 13B of the mover 10B are engaged with the engaging portion 14A and the connecting element 15A of the mover 10A. The engaging element 12A of the mover 10B is engaged with the engaging portion 14A of the mover 10A for electric current transmission. In addition, the connecting element 13B of the mover 10B is engaged with the connecting portion 15A of the mover 10A for driving the electric current of the engaging element 12B of the mover 10B to connect the mover 10A to the mover 10B for achieving a continuous electric current multiplication, so as to increase the push force.

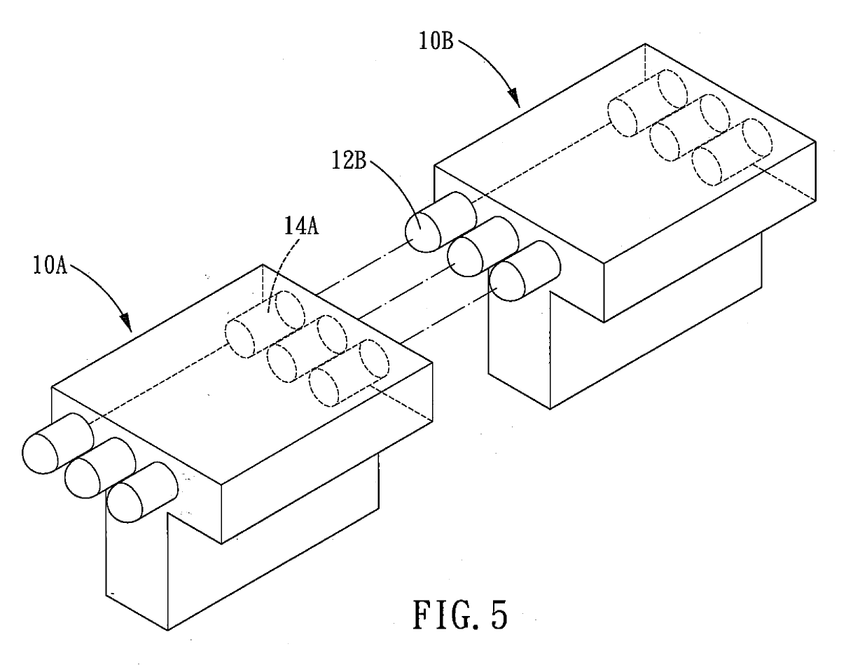

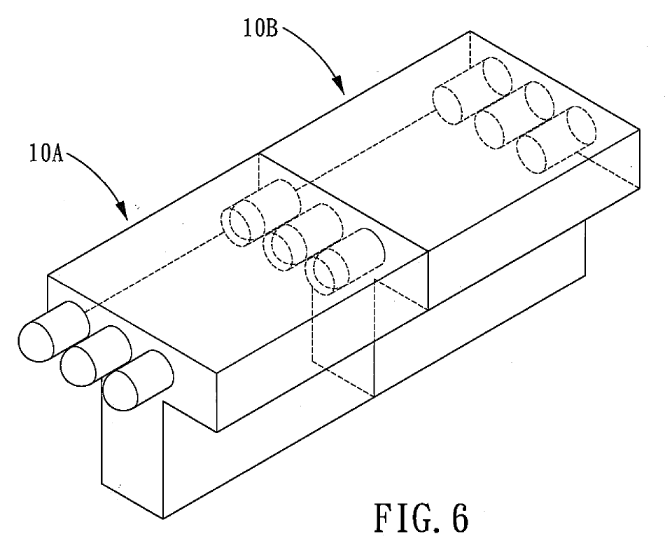

Referring to FIGS. 5-6, which show another embodiment of the present invention, by engaging the engaging element 12 B of the mover 10B with the engaging portion 14A of the mover 10A, the mover 10A can also be connected with the mover 10B to achieve a continuous electric current multiplication to increase the push force.

As known from the abovementioned, the linear motor module of the present invention has the following advantages:

1. Being able to increase or decrease push force: the mover 10 can be connected with at least one mover to achieve a continuous electric current multiplication of the linear motor A, so as to increase the push force.

2. Low cost: since the abovementioned mover 10 can be connected with at least one mover to increase the push force by achieving a continuous electric current multiplication of the linear motor A, thus lowering the purchasing cost of the client and satisfying the economic efficiency.

3. Reducing the manufacturing cost: with the abovementioned mover which can be connected with at least one mover, the continuous electric current multiplication of the linear motor A can be achieved to increase the push force without remolding to offer a function of increasing/decreasing push force for the client, thus enhancing the using efficiency and convenience.

While we have shown and described various embodiments in accordance with the present invention, it is clear to those skilled in the art that further embodiments may be made without departing from the scope of the present invention.

What is claimed is:

1. A mover for a linear motor used together with a stator having at least more than one positive pole magnetic element and at least more than one negative pole magnetic element, comprising:
a body;
at least one engaging element disposed on the body; and
at least one engaging portion disposed on the body and engaged with the engaging element.

2. The mover for a linear motor as claimed in claim 1, wherein the body includes an actuating portion and an adapting portion, and the actuating portion is connected with the positive pole magnetic element or the negative pole magnetic element, and the adapting portion includes the engaging elements and the engaging portions.

3. The mover for a linear motor as claimed in claim 1, wherein the engaging elements are located on one end surface of the adapting portion, and the engaging portions are disposed in an opposite end surface of the adapting portion.

4. The mover for a linear motor as claimed in claim 3, wherein a connecting element and a connecting portion are located beside the engaging elements and the engaging portions respectively, and the connecting element is engaged with the connecting portion.

5. The mover for a linear motor as claimed in claim 1, wherein the mover utilizes its engaging elements to engage with the engaging portions of another mover, and also the mover utilizes its engaging portions to engage with the engaging elements of another mover.

6. A mover for a linear motor used together with a stator having at least more than one positive pole magnetic element and at least more than one negative pole magnetic element, comprising:
a body;
at least one engaging element disposed on the body;
at least one engaging portion disposed on the body and engaged with the engaging element;
at least one connecting element disposed on the body; and
at least one connecting portion disposed on the body and engaged with the connecting element.

7. The mover for a linear motor as claimed in claim 6, wherein the body includes an actuating portion and an adapting portion, and the actuating portion is connected with the positive pole magnetic element or the negative pole magnetic element of the stator, the adapting portion includes the engaging elements, engaging portions, the connecting elements and the connecting portions.

8. The mover for a linear motor as claimed in claim 6, wherein the engaging elements and the connecting elements are disposed on one end surface of the adapting portion, and the engaging portions and the connecting portions are disposed on an opposite end surface of the adapting portion.

9. The mover for a linear motor as claimed in claim 6, wherein the mover utilizes its engaging elements and connecting elements to engage with the engaging portions and connecting portions of another mover, and also the mover utilizes its engaging portions and connecting portions to engage with the engaging elements and connecting elements of another mover.
